(19) United States
(12) Patent Application Publication
(10) Pub. No.: US 2024/0203439 A1
(43) Pub. Date: Jun. 20, 2024

(54) Noise Reduction Based on Dynamic Neural Networks

(71) Applicant: Cerence Operating Company, Burlington, MA (US)

(72) Inventors: Friedrich Faubel, Ulm (DE); Tim Haulick, Ulm (DE); Markus Buck, Ulm (DE)

(21) Appl. No.: 18/285,940

(22) PCT Filed: Nov. 19, 2021
(86) PCT No.: PCT/US2021/060018

§ 371 Date: Oct. 6, 2023

Related U.S. Application Data
(60) Provisional application No. 63/186,066, filed on May 8, 2021.

(51) Int. Cl. G10L 21/0232; G10L 25/18; G10L 25/21; G10L 25/30

(52) U.S. Cl. CPC G10L 21/0232; G10L 25/18; G10L 25/21; G10L 25/30

(57) ABSTRACT

A hybrid noise-reducer provides an output audio signal by carrying out noise reduction on an input audio signal over a desired range of frequencies. The desired range of frequencies consists of the union of a base range of frequencies and a remainder range of frequencies. The noise reducer includes first and second noise-reduction paths of different types. The first noise-reduction path relies on a dynamic neural network that has been trained using the base range of frequencies. The second noise-reduction path relies on a noise estimation module that uses an estimate of signal-to-noise ratio estimate to identify noise within the remainder range.

### RELATED APPLICATIONS

This application claims the benefit of the priority date of U.S. Provisional Application 63/186,066, filed on May 8, 2021, the contents of which are herein incorporated by reference.

### BACKGROUND

Since the earliest days of telephony, background noise has managed to find its way into the signal transmitted by a telephone's microphone. As a result, the intrusion of this noise, it was sometimes difficult for the speaker to be understood.

In the early days, the problem of background noise was solved by the obvious expedient of making the call from a quiet place and holding the microphone close to one's mouth. For many years, telephone companies would place telephones in telephone booths both to promote the caller's privacy and to suppress background noise that might otherwise find its way into the telephone's microphone.

With the advent of mobile telephony, it became possible to make calls from locations that are more difficult to shield from background noise. For example, in a moving motor vehicle, background noise arises from such sources as the sound of the vehicle's own engine that of its tires rolling on the road as well as the vehicle's ventilation system. At higher speeds, even the sound of the wind begins to intrude appreciably on a telephone call. In addition, there exist sources of non-stationary noise, such as the conspicuous periodic clicking of a turn signal or the occasional intrusion of a horn or siren.

The advent of hands-free telephony has exacerbated these difficulties. Placing the microphone further from the caller, as is done in some forms of hands-free telephony, makes it possible for the background noise to more readily interfere with the speaker's voice.

Since physical isolation from such background noise appears to be impractical, it has become necessary to develop electronic noise-reduction systems. Such systems rely on signal processing methods to identify noise and to take steps to either filter it out or cancel it in some way.

Noise can occur at any frequency. Fortunately, practical communication systems have finite bandwidth. It is therefore only necessary to reduce noise at those frequencies that are used in the communication system. Different communication systems have different bandwidths. Thus, the design of a noise-reduction system inevitably depends on the band of frequencies used by the relevant communication system.

### SUMMARY

A dynamic neural network that has been trained to identify various types of noise and to generate spectral weights can be applied to an audio signal's spectrum to achieve noise reduction. A method that relies on a neural network is particularly advantageous because of its ability to handle many different kinds of noise, including non-stationary noise.

A difficulty that arises with use of a neural network is its lack of flexibility. A neural network must, after all, be trained. Training a neural network for noise reduction includes training it for a particular band of audio frequencies. Using the neural network in a different band of audio frequencies will result in a significant loss of effectiveness.

This difficulty arises because different communication systems have different bandwidth requirements over which noise reduction is to take place. For example, narrowband systems only require noise reduction to about 3,700 Hz. However, there also exist telephony standards that impose thresholds of 7 kilohertz, 11.5 kilohertz, 16 kilohertz, and 24 kilohertz. Speech-recognition systems typically rely on a band that ends at 8 kilohertz.

One might consider the possibility of maintaining an inventory of different neural networks for different frequency bands. However, the effort that goes into training a neural network is not trivial. Thus, such a solution is economically prohibitive.

The invention provides a way to carry out noise reduction over a range of frequencies that extends beyond that for which a dynamic neural network was originally trained. The method and system disclosed herein leverages the dynamic neural network by using it to dynamically modify a filter that is being used to reduce noise at frequencies for which it has not been trained.

In one aspect, the invention features a hybrid noise-reducer that provides an output audio signal by carrying out noise reduction on an input audio signal over a desired range of frequencies. The desired range of frequencies consists of the union of a base range of frequencies and a remainder range of frequencies.

The noise reducer is a hybrid noise reducer because it includes first and second noise-reduction paths of different types. The first noise-reduction path relies on a dynamic neural network that has been trained using the base range of frequencies. The second noise-reduction path relies on a noise estimation module that uses an estimate of signal-to-noise ratio to identify noise within the remainder range.

A frequency-domain representation of the incoming audio signal is divided into first and second signal constituents corresponding to the base and remainder ranges. For convenience, these signal constituents will be referred to as the “base constituent” and “remainder constituent” respectively.

The base constituent is provided to the first noise-reduction path and the remainder constituent is provided to the second noise-reduction path. The first and second noise-reduction paths compute corresponding first and second sets of spectral weights for application to the base and remainder constituents, respectively. However, the second noise-reduction path receives, from the first noise-reduction path, information concerning noise in the first signal constituent and uses that information to modify the second set of spectral weights.

The first and second sets of spectral weights are then applied to the base and remainder constituents, respectively. This results in a filtered base constituent and a filtered remainder constituent, which are then combined to form the spectrum of the output signal. The resulting combination, in the time domain, becomes the output signal.

A hybrid noise reducer as described herein avoids the need to train dynamic neural networks for different bandwidths. Instead, it becomes possible to train one base dynamic neural network using a base frequency range that is a subset of the desired frequency range for noise reduction and to use a different noise-reduction system for the remainder of the desired frequency range. This avoids the cost of training new dynamic neural networks for particular uses. It also takes advantage of the greater availability of training data for the base frequency range and the ability to inform the noise reduction process in the remainder range based on the result of noise reduction in the base range.

Yet another advantage is that the dynamic neural network, because it processes only the base range, requires fewer nodes. This saves on computational resources and on energy usage.

In one aspect, the invention features an apparatus for generating an output audio signal by suppressing noise in a first input spectrum and noise in a second input spectrum, the first and second input spectra having been obtained from an input audio signal. The first input spectrum represents that energy that is present in the input audio signal and that is within a first frequency band. The second input spectrum represents that energy that is present in the input audio signal and that is within a second frequency band. The apparatus includes a hybrid noise-reduction system that includes a first noise-reduction path that receives the first input spectrum and a second noise-reduction path that receives the second input spectrum. The first noise-reduction path is configured to apply a first noise-reduction method to the first input spectrum to produce a first noise filter for reducing noise in the first input spectrum. The second noise-reduction path is configured to apply a second noise-reduction method to the second input spectrum to produce a second noise filter for reducing noise in the second input spectrum. These two noise-reduction methods differ from each other. The second noise-reduction path includes weighting circuitry that modifies the second noise filter based at least in part on the first noise filter, thereby generating a third noise filter.

Among the embodiments are those in which the hybrid noise-reduction system further includes a filtering system that is configured to apply the first noise filter to the first input spectrum and to apply the third noise filter to the second input spectrum to yield a filtered first input spectrum and a filtered second input spectrum, respectively.

Also among the embodiments are those in which the hybrid noise-reduction system further includes stacking circuitry that combines filtered first and second input spectra into an output spectrum that represents a frequency-domain representation of the input audio signal with noise having been suppressed therein.

Some embodiments also include a transform circuit that receives the input audio signal and provides a frequency-domain representation of the input audio signal from which the first and second input spectra are obtained. Among these are embodiments in which the transform circuit that is configured to carry out a short-term Fourier transform of the input audio signal.

Other embodiments include inverse-transform circuitry that converts an output spectrum into the output audio signal, the output spectrum being representative of a frequency-domain representation of the input audio signal with noise having been suppressed therein. Among these are embodiments in which the inverse-transform circuitry carries out an inverse short-term Fourier transform to convert an output spectrum into the output audio signal, the output spectrum being representative of a frequency-domain representation of the input audio signal with noise having been suppressed therein.

In still other embodiments, the first noise-reduction path includes a dynamic neural network that produces the first noise filter based on features extracted from the first input spectrum. Among these are embodiments in which the dynamic neural network provides a voice-activity signal indicative of the presence of speech. Also among these are embodiments in which the dynamic neural network that was trained using frequencies in the first band.

Other embodiments include those in which the first noise-reduction path is configured to provide a voice-activity signal indicative of voice activity in the first input spectrum and to provide the voice-activity signal to the weighing circuitry for use in modifying the second filter.

In other embodiments, the second noise-reduction path includes an estimator and a filter calculator that determines the second noise filter based on a noise estimate provided by the estimator.

Also among the embodiments are those in which the weighting circuitry is configured to modify the second noise filter to cause the third noise filter to suppress noise that would not have been suppressed by the second noise filter had the second noise filter been applied to the input remainder-spectrum.

Still other embodiments include those in which the weighting circuitry is configured to modify the second noise filter to prevent the third noise filter from suppressing power present in the input remainder-spectrum that would have been suppressed by the second noise filter had the second noise filter been applied to the input remainder-spectrum.

In yet other embodiments, there exists a first probability and a second probability with the first probability being a probability that speech is present in the input remainder-spectrum and the second probability being a conditional probability that speech is present in the input remainder-spectrum given information concerning the presence of speech in the input base-spectrum. In such embodiments, the weighting circuitry is configured to modify the second noise filter based on a function of the first and second probabilities.

Embodiments further include those in which the input base-spectrum has an upper bound of 7 kilohertz and those in which the remainder base-spectrum has a lower band that is equal to an upper bound of the input base-spectrum.

Still other embodiments include those in which the remainder base-spectrum has an upper bound that is equal to twenty-four kilohertz, those in which the upper bound is 11.5 kilohertz, those in which the upper bound is 16 kilohertz, and those in which the upper bound is at 8 kilohertz.

In another aspect, the invention features a method that includes reducing noise in an input audio signal by splitting a frequency-domain representation of the input audio signal into first and second input spectra, using a first noise-reduction method, generating a first filter for reducing noise in the first input spectrum, thereby generating a first output spectrum, using a second noise-reduction method that includes use of information obtained from having used the first noise-reduction method, generating a second filter for reducing noise in the second input spectrum, thereby generating a second output spectrum, and outputting a time-domain signal formed from having transformed a frequency-domain signal that resulted from having combined the first and second output spectra.

These and other features of the invention will be apparent from the following detailed description and the accompanying figures in which:

### BRIEF DESCRIPTION OF THE DRAWINGS

FIG. 1 shows a hybrid noise-reducer having first and second noise-reduction paths corresponding to a baseband and a remainder band, respectively;

FIG. 2 shows the baseband and the remainder band used in FIG. 1;

FIG. 3 shows a range of frequencies used for determining gain to be applied to filter coefficients produced by the second noise-reduction path shown in FIG. 1;

FIG. 4 shows an alternative embodiment of the hybrid noise-reducer of FIG. 1; and

FIG. 5 shows a noise-reduction method.

### DETAILED DESCRIPTION

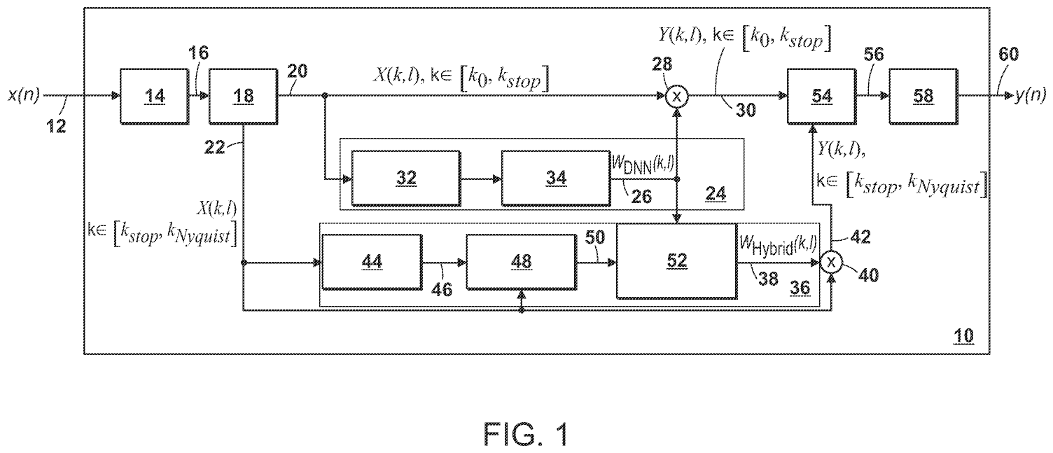

FIG. 1 shows circuitry for implementing a hybrid noise-reducer 10 that receives an input audio-signal 12, x(n), that is formed by sampling a time-domain audio signal. In a typical embodiment, the time-domain audio signal is sampled at 16 kHz to generate the input audio-signal 12. For convenience in processing, the input audio-signal 12 is partitioned into blocks of uniform length. In a typical embodiment, a block has 256 samples.

A transform circuit 14 transforms each block of the input audio-signal 12 into an input spectrum 16. This input spectrum 16, which is represented in the figures by X(k, l), is a frequency-domain representation of a particular block of the input audio-signal 12. The argument l identifies a particular time-slice, and the argument k identifies a particular frequency.

A suitable transform circuit 14 is one that implements a transform based on a set of orthogonal eigenfunctions. In a preferred embodiment, the transform is a short-term Fourier transform, which is based on a discrete Fourier transform. In an embodiment in which the blocks have 256 samples, the transform circuit 14 implements a discrete Fourier transform of length 512. This results in a vector of 257 complex-valued coefficients that define the input spectrum 16. A splitter 18 then receives the input spectrum 16 from the transform circuit 14 and splits it into an input base-spectrum 20 and an input remainder-spectrum 22.

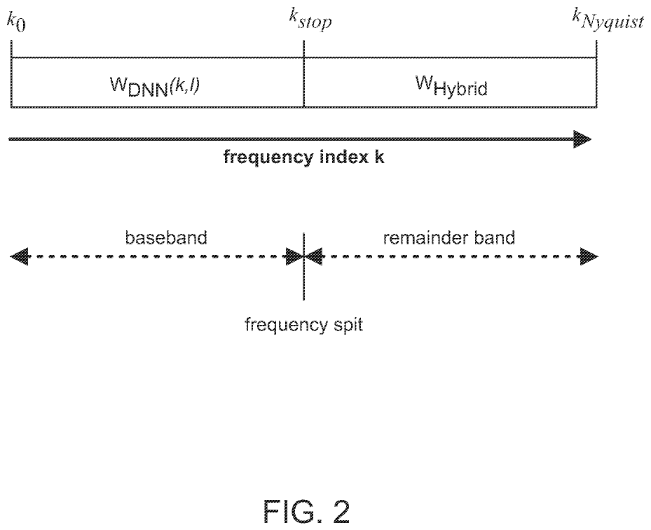

Referring now to FIG. 2, the input base-spectrum 20 is that portion of the input spectrum 16 that lies within a “base band.” This base band extends from a low base frequency, kₒ, to a higher stop frequency, kₛₜₒₚ. Embodiments include those in which the base band is one that extends up to a stop frequency of seven kilohertz from a base frequency of fifty hertz.

The input remainder-spectrum 22 comprises those frequency components of the input spectrum 16 that are in a “remainder band.” The remainder band extends from the stop frequency up to a cap frequency. In a typical embodiment, the cap frequency corresponds to half the sampling frequency, k_{Nyquist}.

The cap frequency is dictated by requirements of communication networks with which the hybrid noise-reducer 10 interacts. Examples include cap frequencies of 8 kHz, 11.5 kHz, 16 kHz, and 24 kHz. In those embodiments in which communication with a speech-recognition systems is carried out, the cap frequency is at 8 kHz.

Referring back to FIG. 1, the input base-spectrum 20 is provided to a first noise-reduction path 24. The first noise-reduction path 24 calculates first spectral-coefficients 26, W_{DNN}(k, l), that define a filter. The first spectral-coefficients 26 are then provided to a first multiplier 28.

The first multiplier 28 also receives the input base-spectrum 20. The first multiplier 28 weights the input base-spectrum 20 with the first spectral-coefficients 26 to obtain an output base-spectrum 30 that extends across the baseband, i.e., Y(k, l) for k ϵ[kₒ, kₛₜₒₚ]. The output base-spectrum 30 corresponds to the input base-spectrum 20 but with noise having been suppressed by the first noise-reduction path 24.

In a preferred embodiment, a first spectral-coefficient 26 that corresponds to a frequency within the baseband takes on a value indicative of the likelihood that the power present in the input base-spectrum 20 at that frequency is speech. Thus, if power corresponding to a frequency in the input base-spectrum 20 is certain to be noise, then the first spectral-coefficient 26 for that frequency will be zero. In some embodiments, the first spectral-coefficient 26 is binary. In others, it takes on any one of a finite number of intermediate values depending on an extent to which the power in that frequency component of the input base-spectrum 20 is believed to be speech.

The first noise-reduction path 24 comprises a feature-extraction circuit 32 that receives the input base-spectrum 20 and extracts feature information from the input base-spectrum 20. The feature-extraction circuit 32 then provides data representative of those features to a dynamic neural network 34. The dynamic neural network 34 is one that has been trained to operate within the base band. Based in part on this feature information, the dynamic neural network 34 outputs the first spectral-coefficients 26.

Meanwhile, the input remainder-spectrum 22 is provided to a second noise-reduction path 36 that ultimately provides a filter, which is defined by second spectral-coefficients 38, W_{Hybrid}(k, l), to a second multiplier 40. The second multiplier 40 weights the input remainder-spectrum 22 with the second spectral-coefficients 38 to obtain an output remainder-spectrum 42 that extends across the remainder band, i.e., Y(k, l) for k ϵ[kₛₜₒₚ, k_{Nyquist}].

The second noise-reduction path 36 comprises a noise estimator 44 that receives the input remainder-spectrum 22 and provides an estimate 46 of the noise that is present within it. That estimate 46, along with the input remainder-spectrum 22, is provided to a filter calculator 48.

The filter calculator 48 outputs a filter comprising filter coefficients 50 that have been selected to suppress noise present in the input remainder-spectrum 22. A filter coefficient 50 corresponding to a frequency component of the input remainder-spectrum 22 takes on a value indicative of the likelihood that the power present at that frequency is speech. Thus, if power corresponding to a frequency is certain to be noise, then the filter coefficient 50 for that frequency will be zero. In some embodiments, the filter coefficient 50 is binary. In others, it takes on any one of a finite number of intermediate values depending on an extent to which the power in that frequency component of the input remainder-spectrum 22 is believed to be speech.

In some embodiments, the filter calculator 48 obtains a filter coefficient 50 by dividing the difference between the magnitude of the complex-valued input remainder-spectrum 22 and the magnitude of the estimate 46 by the magnitude of the complex-valued input remainder-spectrum 22. This results in a filter coefficient 50 that is equal to unity when the noise estimator 44 determines that no noise is present and that is equal to zero when the noise estimator 44 regards the entire input remainder-spectrum 22 as being noise.

At a particular instant in time, the occurrence of noise in the input base-spectrum 20 and the occurrence of noise in the input remainder-spectrum 22 are not necessarily independent events. For example, certain noise sources, such as the clicking of a turn signal, are broadband and, as such, should exist at the same time in both the input remainder-spectrum 22 and the input base-spectrum 20. Thus, in some cases, the probability of a noise event in the input remainder-spectrum 22 is a conditional probability that is influenced by the detection of a concurrent noise event in the input base-spectrum 20.

Since the first spectral-coefficients 26 are, in effect, a measure of the probability of speech in the input base-spectrum 20, it is useful to leverage them by supplying them, along with the filter coefficients 50, to weighting circuitry 52. The weighting circuitry 52 modifies the filter coefficients 50 based on the corresponding first spectral-coefficients 26. The resulting modification yields the second spectral-coefficients 38.

In one example, the filter coefficients 50 indicate the presence of speech and the first spectral-coefficients 26 indicate the absence of speech. In such a case, the weighting circuitry 52 exercises veto power over the filter coefficients 50 and modifies them to indicate the absence of speech. This is reflected in the second spectral-coefficients 38. Another example is the converse of the foregoing.

Yet other examples are those in which the filter coefficients 50 are weighted by some value indicative of the probability, based on the first spectral-coefficients 26, that the filter coefficients 50 characterize speech. Among these are embodiments in which a secondspectral-coefficient 38 is obtained by multiplying a corresponding filter coefficient by a gain that is in the interval [0, 1], i.e., W_{Hybrid}(k, l)=g·W_{Conv}(k, l), where W_{Conv}·(k, l) is a filter coefficient 50 and W_{Hybrid}(k, l) is a second spectral coefficient 38.

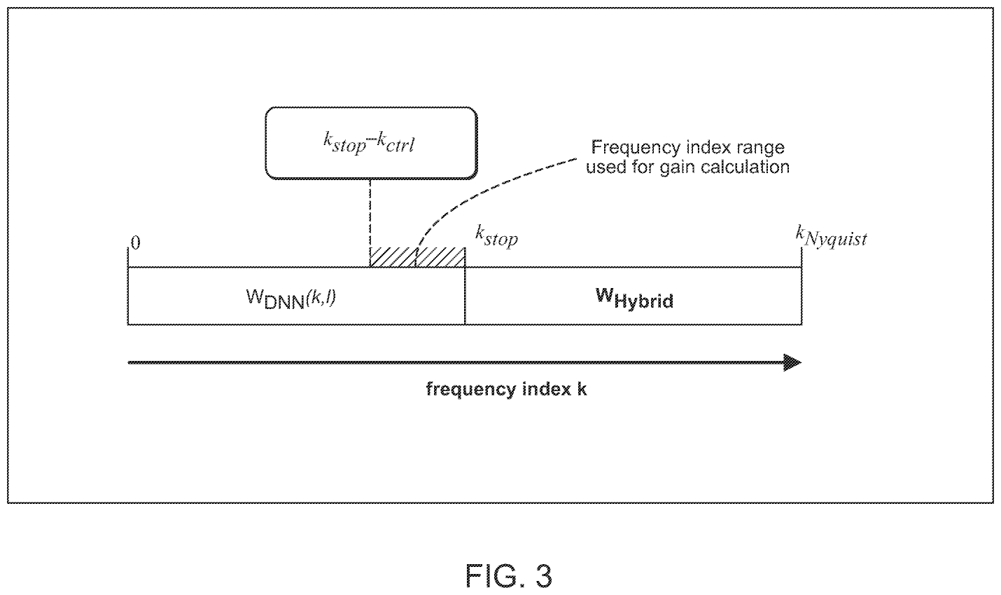

A useful method is to set the foregoing gain based on a multivariate function of those first spectral-coefficients 26 that are within a window of frequencies, referred to herein as the “control window.” as shown in FIG. 3. A suitable control window is one that extends downward from the stop frequency. Suitable embodiments include those in which the averaging window extends downward by 1 kHz from the stop frequency and those in which the averaging window extends downward by 2 kHz from the stop frequency. A particularly simple multivariate function is the average value of the first spectral-coefficients 26 that are within the control window.

The output base-spectrum 30 and the output remainder-spectrum 42 are both provided to a stacking circuit 54 that concatenates the base band and remainder band together to form an output spectrum 56. An inverse-transform circuit 58 receives the output spectrum 56 and carries out the inverse of the transform carried out by the transform circuit 14. In the illustrated embodiment, since the transform circuit 14 carried out a short-term Fourier transform, the inverse-transform circuit 58 carries out an inverse short-term Fourier transform. This results in an output audio signal 60, y(n), that corresponds to the input audio signal 12 but with noise having been removed from both the base band and the remainder band.

The hybrid noise-reducer 10 thus provides two separate and distinct noise-reduction systems 24, 36 that carry out noise reduction in two separate and distinct frequency bands (the base band and the remainder band) but with one of the noise-reduction systems, namely the second noise-reduction path 36, basing its noise reduction at least in part on information derived from the other, namely the first noise-reduction path 24.

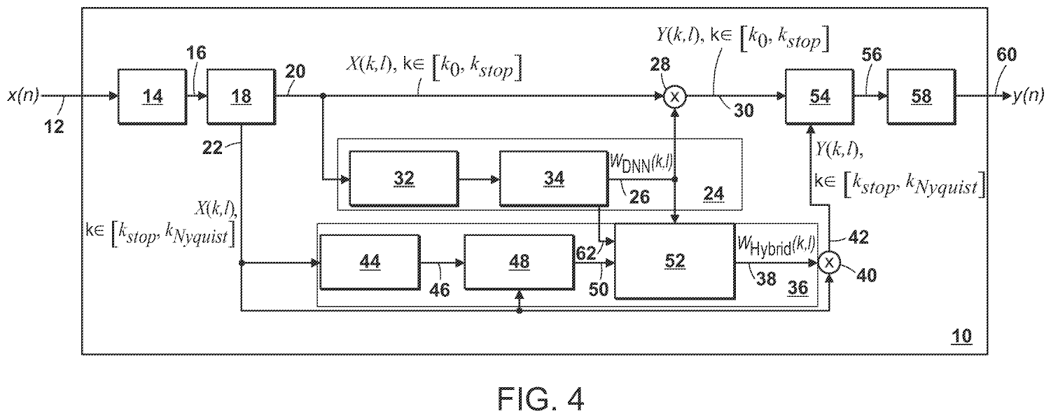

FIG. 4 shows circuitry similar to that in FIG. 1 but with the dynamic neural network 34 having been endowed with an ability to detect the existence of a voice in the input base-spectrum 20. The dynamic neural network 34 in this embodiment provides a voice-activity signal 62 to the weighting circuitry 52 to permit the weighting circuitry 52 to account for the existence of voice activity in the input base-spectrum 20 when modifying the filter coefficients 50 in view of the findings made in the first noise-reduction path 24.

In the embodiment shown in FIG. 4, it is possible to include, as an argument in the multivariate function that is used to determine the gain, a value indicative of the presence of a voice signal or speech within the time slice that corresponds to the set of first spectral-coefficients 26 being used to calculate the gain. Examples of such an additional argument include those that include information indicative of voice-activity or the presence of a phoneme.

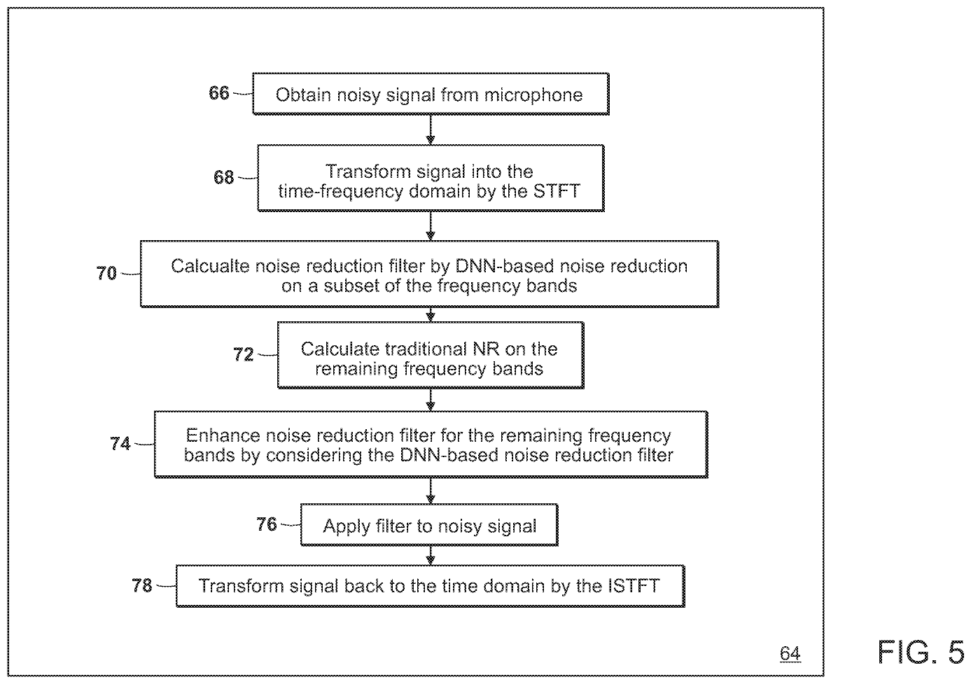

As shown in FIG. 5, a method 64 carried out by the circuitry shown in FIGS. 1 and 4 begins with a receiving step 66 in which a noisy signal is obtained from a microphone. This is followed by a transform step 68 in which a finite block from a sampled representation of the audio signal, namely the input audio signal 12, is transformed into its frequency-domain representation, thereby resulting in the input spectrum 16. The input spectrum 16 includes an input base-spectrum 20 and an input remainder-spectrum 22 corresponding to the two frequency bands: the base band and a remainder band. The base band is one that is common to a variety of communication networks and the remainder band corresponds to those frequencies used in a particular communication network that lie beyond the base band.

The method 64 continues with a baseband noise-reduction step 70, which is carried out on the input base-spectrum 20 using a dynamic neural network 34, and a remainder-band noise-reduction step 72 that is carried out on the remainder base-spectrum 22 using a power-spectrum estimation method. These noise-reduction steps 70, 72 need not be carried out serially as shown but that can also be carried concurrently or at overlapping time intervals.

The remainder-band noise-reduction step 72 produces certain intermediate results that are then modified during an enhancement step 74. This enhancement step 74 includes consideration of results found by the dynamic-neural network 34 during the base noise-reduction step 70.

The method 64 continues with a filtering step 76, in which the relevant filters are applied to the input base-spectrum 20 and the input remainder-spectrum 22 to form a corresponding output base-spectrum 30 and output remainder-spectrum 42 respectively. The resulting output base-spectrum 30 and output remainder-spectrum 42 are then combined and transformed back into the time domain in an inverse transform step 78.

The hybrid noise-reducer 10 and its method of operation collectively avoids the need to train a new dynamic neural network 34 every time a new communication standard is adopted. Instead, a single dynamic neural network 34 is used for all communication networks to suppress noise in a band that is common to all such communication networks. The remaining frequencies, for which the dynamic neural network 34 would not have been trained, are then processed by a different noise-reduction circuitry that does not require extensive training. However, a synergy arises because the output of the dynamic neural network 34 is used to inform the process carried out by the different noise-reduction system.

The embodiment shown bifurcates the input spectrum 16 into two bands 20, 22. However, the principles described herein are applicable to embodiments in which the input spectrum 16 is divided into more than two bands with different bands being processed by different noise-reduction systems 24, 36, of which at least two differ from each other and in which the output of one noise-reduction system 24 affects the operation of another of the noise-reduction systems 36 that differs from the one noise-reduction system 24 in its manner of carrying out noise reduction.

Having described the invention and a preferred embodiment thereof, what is claimed as new and secured by Letters Patent is:

1. An apparatus for generating an output audio signal (60) by suppressing noise in a first input spectrum (20) and noise in a second input spectrum (22), said first and second input spectra (20, 22) having been obtained from an input audio signal (12),
wherein said first input spectrum (20) represents first energy,
wherein said second input spectrum (22) represents second energy,
wherein said first energy is energy that is present in said input audio signal (12) and that is within a first frequency band, and
wherein said second energy is energy that is present in said input audio signal (12) and that is within a second frequency band,
said apparatus comprising a hybrid noise-reducer (10) that comprises a first noise-reduction path (24) and a second noise-reduction path (36),
wherein said first noise-reduction path receives said first input spectrum (20),
wherein said second noise-reduction path (36) receives said second input spectrum (22),
wherein said first noise-reduction path (24) is configured to apply a first noise-reduction method to said first input spectrum (20) by producing a first noise filter (26) for reducing noise in said first input spectrum (20),
wherein said second noise-reduction path (36) is configured to apply a second noise-reduction method to said second input spectrum (22) by producing a second noise filter (50) for reducing noise in said second input spectrum (22), and
wherein said second noise-reduction path (36) comprises weighting circuitry (52) that modifies said second noise filter (50) based at least in part on said first noise filter (26), thereby generating a third noise filter (38).

2. The apparatus of claim 1, wherein said hybrid noise-reduction system (10) further comprises multipliers (28, 40) that are configured to apply said first noise filter (26) to said first input spectrum (20) and to apply said third noise filter (38) to said second input spectrum (22) to yield a filtered first input spectrum (30) and a filtered second input spectrum (42), respectively.

3. The apparatus of claim 1, wherein said hybrid noise-reduction system (10) further comprises stacking circuitry (54) that combines filtered first and second input spectra (30, 42) into an output spectrum (56) that represents a frequency-domain representation (16) of said input audio signal (12) with noise having been suppressed therein.

4. The apparatus of claim 1, further comprising a transform circuit (14) that receives said input audio signal (12) and provides a frequency-domain representation of said input 9 audio signal (12) from which said first and second input spectra (20, 22) are obtained.

5. The apparatus of claim 1, further comprising a transform circuit (14) that is configured to carry out a short-term Fourier transform of said input audio signal (12).

6. The apparatus of claim 1, wherein said hybrid noise-reduction system (10) further comprises inverse-transform circuitry (58) that converts an output spectrum (56) into said output audio signal (60), said output spectrum (56) being representative of a frequency-domain representation of said input audio signal (12) with noise having been suppressed therein.

7. The apparatus of claim 1, wherein said hybrid noise-reduction system (10) further comprises inverse-transform circuitry (58) that carries out an inverse short-term Fourier transform to convert an output spectrum (56) into said output audio signal (60), said output spectrum (56) being representative of a frequency-domain representation (16) of said input audio signal (12) with noise having been suppressed therein.

8. The apparatus of claim 1, wherein said first noise-reduction path (24) comprises a dynamic neural network (34) that produces said first noise filter (26) based on features extracted from said first input spectrum (20).

9. The apparatus of claim 1, wherein said first noise-reduction path (24) is configured to provide a voice-activity signal (62) indicative of voice activity in said first input spectrum (20) and to provide said voice-activity signal (62) to said weighing circuitry (52) for use in modifying said second filter (50).

10. The apparatus of claim 1, wherein said first noise-reduction path (24) comprises a dynamic neural network (34) that was trained using frequencies in said first band.

11. The apparatus of claim 1, wherein said second noise-reduction path (36) comprises an estimator (44) and a filter calculator (48) that determines said second noise filter (50) based on a noise estimate provided by said estimator (44).

12. The apparatus of claim 1, wherein said weighting circuitry (52) is configured to modify said second noise filter (50) to cause said third noise filter (38) to suppress noise that would not have been suppressed by said second noise filter (50) had said second noise filter (50) been applied to said input remainder-spectrum (22).

13. The apparatus of claim 1, wherein said weighting circuitry (52) is configured to modify said second noise filter (50) to prevent said third noise filter (38) from suppressing power present in said input remainder-spectrum that would have been suppressed by said second noise filter (50) had said second noise filter (50) been applied to said input remainder-spectrum (22).

14. The apparatus of claim 1,
wherein there exists a first probability and a second probability,
wherein said first probability is a probability that speech is present in said input remainder-spectrum (22),
wherein said second probability is a conditional probability that speech is present in said input remainder-spectrum (22) given information concerning the presence of speech in said input base-spectrum (20), and
wherein said weighting circuitry (52) is configured to modify said second noise filter (50) based on a function of said first and second probabilities.

15. The apparatus of claim 1, wherein said input base-spectrum has an upper bound of seven kilohertz.

16. The apparatus of claim 1, wherein said remainder base-spectrum has a lower band that is equal to an upper bound of said input base-spectrum.

17. The apparatus of claim 1, wherein said remainder base-spectrum has an upper bound that is equal to twenty-four kilohertz.

18. The apparatus of claim 1, wherein said remainder base-spectrum has an upper bound that is equal to 11.5 kilohertz.

19. A method comprising reducing noise in an input audio signal, wherein reducing said noise comprises
splitting a frequency-domain representation of said input audio signal into first and second input spectra,
using a first noise-reduction method, generating a first filter for reducing noise in said first input spectrum, thereby generating a first output spectrum,
using a second noise-reduction method that includes use of information obtained from having used said first noise-reduction method, generating a second filter for reducing noise in said second input spectrum, thereby generating a second output spectrum, and
outputting a time-domain signal formed from having transformed a frequency-domain signal that resulted from having combined said first and second output spectra.
